(19) United States
(12) Patent Application Publication
(10) Pub. No.: US 2008/0133438 A1
(43) Pub. Date: Jun. 5, 2008

(54) SYSTEM AND METHOD FOR FEATURE BASED LOAD SHEDDING IN CLASSIFICATION

(75) Inventors: Charu C. Aggarwal, Yorktown Heights, NY (US); Haixun Wang, Irvington, NY (US)

Correspondence Address: CANTOR COLBURN LLP - IBM RESEARCH TRIANGLE PARK, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/564,885

(22) Filed: Nov. 30, 2006

(51) Int. Cl. G06N 5/00

(52) U.S. Cl. 706/20

(57) ABSTRACT

A system and method for feature based load shedding in classification. The system includes a plurality of data sources. The plurality of data sources being configured to render independent streams of input data, such data being selectively grouped together to form a particular classification task. The system further includes a central classification server configured to analyze and execute multiple tasks, each task consisting of multiple input data. The central classification server further configured to analyze the data for knowledge-based decision-making. The central classification server being communicatively engaged via a network to the plurality of data sources. The method includes rendering independent streams of input data, such data being selectively grouped together to form a particular task. The method further includes analyzing and handling multiple tasks, each task consisting of multiple input data. The method also includes analyzing the data for knowledge-based decision-making.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF INVENTION

1. Field of Invention

This invention relates in general to data handling, and more particularly, to a central processing server configured to handle data for feature based load shedding.

2. Description of Background

In many applications, data from multiple sources (e.g., data collected by different types of sensors) arrives continuously at a central processing site, which analyzes the data for knowledge-based decision making. Typically, the central site handles a multitude of such tasks at the same time, which makes resource management a major issue for many applications. In particular, under overloaded situations, policies of load shedding must be developed for incoming data so that quality of decision-making is least affected.

The central processing site monitors data sources for detection of events of interest. Because of various constraints including network bandwidth and computation capacity, the central processing site cannot afford to inspect each data item (some inspection may involve feature extraction and other data preprocessing steps, which is expensive), yet it still needs to render high quality classification decisions.

Thus, there is a need for a system and method for load shedding for multi-task multi-data source classification applications.

### SUMMARY OF THE INVENTION

The shortcomings of the prior art are overcome and additional advantages are provided through the provision of a system for feature based load shedding in classification. The system includes a plurality of data sources. The plurality of data sources are configured to render independent streams of input data, such data being selectively grouped together to form a particular classification task. The system further includes a central classification server configured to analyze and handle multiple tasks, each task consisting of multiple input data. The central classification server is further configured to analyze the data for knowledge-based decision-making. The central classification server is communicatively engaged via a network to the plurality of data sources.

The shortcomings of the prior art are overcome and additional advantages are provided through the provision of a method for feature based load shedding in classification. The method includes rendering independent streams of input data, such data being selectively grouped together to form a particular classification task. The method further includes analyzing and handling multiple tasks, each task consisting of multiple input data. The method also includes analyzing the data for knowledge-based decision-making.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution for a system and method for feature based load shedding in classification.

### BRIEF DESCRIPTION OF THE DRAWINGS

The subject regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a system for feature based load shedding in classification, in accordance with the disclosed invention;

FIG. 2 illustrates one example of task movement in the feature space of the system shown in FIG. 1;

FIGS. 3(a)-3(b) illustrate one example of a joint and conditional distribution of the system shown in FIG. 1;

FIGS. 4(a)-4(c) illustrate one example of Bayes Risk Composition executed with the system shown in FIG. 1;

FIG. 5 illustrate one example of a method for feature based load shedding in classification, in accordance with the disclosed invention.

The detailed description explains an exemplary embodiment of the invention, together with advantages and features, by way of example with reference to the drawings.

### DETAILED DESCRIPTION OF THE INVENTION

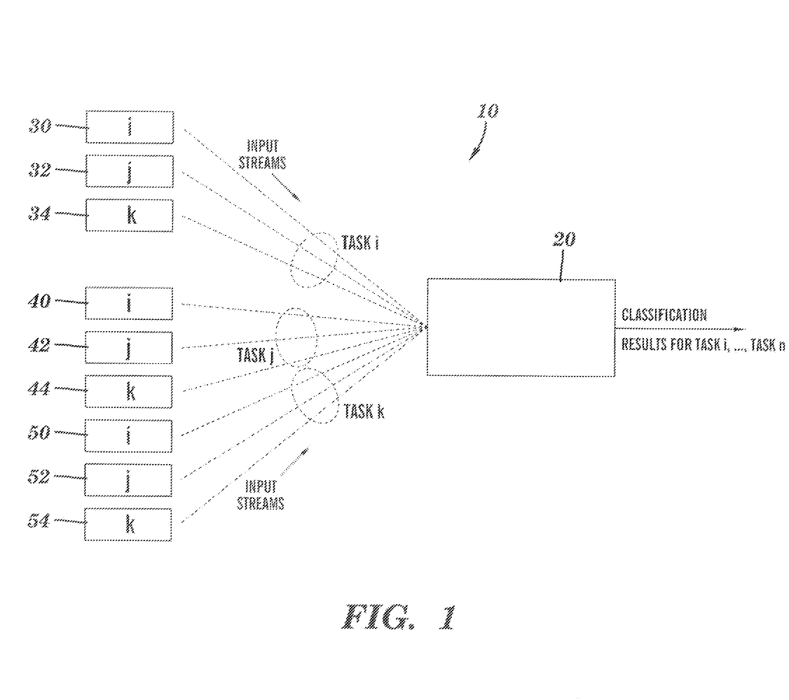

Referring to FIG. 1, it will be seen that a system 10 for feature based load shedding in classification, is shown.

A central classification server 20 is configured to handle n independent classification tasks, where each task processes a multiple number of input data. A plurality of data sources 30, 32, 34, 40, 42, 44, 50, 52 and 54 are communicatively engaged with the central classification server 20. Assume some of the tasks have i data sources 30, 40 and 50, j data sources 32, 42 and 52, and k data sources 34, 44 and 54.

Suppose at a given moment, the central classification server 20, which monitors n×k streams from n tasks, only has capacity to process m out of the n×k input streams. This leaves the decision of determining which of the input streams should be inspected so that the classification quality is least affected. The following examples illustrate situations that give rise to the problem.

A security application monitors many locations with security cameras. At each location, multiple cameras are set up at different viewing angles since the speed and direction of a moving object cannot be determined precisely if only one viewing angle is used. As a result, each location generates multiple images or video streams and sends them to the central server for classification. In this case, data from different cameras are of the same type but they have different semantics (different viewing angles).

In environment monitoring, a central classifier makes decisions based on a set of factors, such as temperature, humidity, wind-speed, etc., each obtained by sensors distributed in a wireless network over a wide geographical region. In this case, multiple data sources for one task contains different types of information.

An inherent challenge to the problem is that the central task of decision making cannot be easily offloaded to each data source 30, 32, 34, 40, 42, 44, 50, 52 and 54, as classification depends on information from all of the k data sources 34, 44 and 54. On the other hand, in most situations, it is safe to assume that at any given time, there exist only a small number of events of potential interest, which means, even if m<<n×k, it is still possible to monitor all the tasks and catch all events of interest if the user knows how to intelligently shed loads.

The goal of intelligent load shedding is to reduce the cost of the stream classification process while maintaining the quality of classification. The following factors may have significant implications on the overall cost.
Cost of data preprocessing: Raw data from the sources may have to be preprocessed before classification algorithms can be applied. For example, for video streams, extracting frames from a video and extracting features from key frames can be a very costly process.
Cost of data transmission: Delivering large amounts of data from remote data sources to the centralized server may incur considerable cost.
Cost of data collection: Data may be costly to obtain to begin with, this may limit the sampling rate of a sensor, or its on-line due to energy conservation concerns.

Cost is reduced if high quality decisions can be made with less amounts of data. Embodiments disclosed address the following challenges of randomly shedding load, relying on user-provided QoS metrics to shed load and solving the special case of k=1.

Randomly shedding load: While dropping data indiscriminately and randomly from incoming data streams is one choice, such methods lead to degradation of classification quality. In many cases, not all incoming data contribute equally to the overall quality of classification.

User provided QoS metrics to shed load: User-provided QoS specifications assume that the user has a priori knowledge about how data contributes to the quality. In other words, a source 30, 32, 34, 40, 42, 44, 50, 52 and 54 can apply a QoS metric f on a data item x̅=(x₁, . . . , xₙ), and the value of f( x̅) indicates to what extent dropping x̅ negatively impacts the quality. Unfortunately, some applications operate in a dynamically changing environment, which means even if QoS is known, it is unlikely to stay static. The multi-source setting introduces more restrictions in using QoS—even if there is a metric for the collective x̅, there may not be metrics for each component x₁ of x̅, which means sources 30, 32, 34, 40, 42, 44, 50, 52 and 54 still cannot drop the data.

Solving the special case of k=1: Each classification task has only one data source (k=1). At any time, it decides which task to work on. Thus, the load shedding decisions are made on a task-by-task basis and it does not take into consideration the fact that different features of the data may contribute differently to the overall quality. In fact, for k=1, offload classification tasks can safely be loaded from the centralized classification server 20 to each data source 30, 32, 34, 40, 42, 44, 50, 52 and 54, which already has complete information to make load shedding decisions. However, for multi-source classification tasks, load shedding cannot be offloaded to the source 30, 32, 34, 40, 42, 44, 50, 52 and 54, as only the central classification server 20 has complete information about each task.

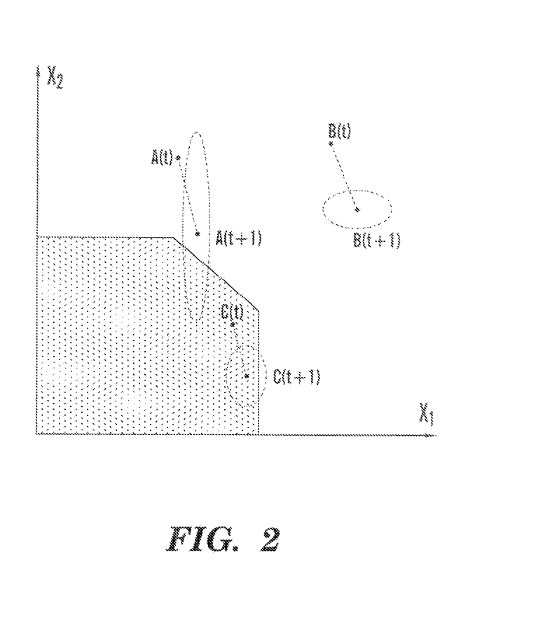

For example, assume a classification task monitors two data sources X₁ and X₂ for threats. Each of the sources sends a single feature stream. Thus, at any time t, the state of a task can be modeled as a point in a two-dimensional feature space. In FIG. 2, three possible states of the task at time t, which are denoted as A(t), B(t), and C(t) are shown. Furthermore, the assumption is made that the feature space is divided into two areas such that points in the shaded area represent threats, and points in the unshaded area represent non-threats.

Let p be the probability distribution of a point's position at time t+1 given its position at time t. The example in FIG. 2 illustrates p as a normal distribution and it also assumes that the two features X₁ and X₂ are independent. Knowing the distribution p enables the user to form some load shedding strategies, which can be used to guide the data observation (e.g. feature extraction, video analysis) at time t+1.

First, different tasks should be given different priorities when data is observed. For example, according to p, the next position of B is far away from the decision boundary, so without making data observation at time, B can already be classified with high confidence. This is not true for A and C, for which data observations are necessary for better classification accuracy.

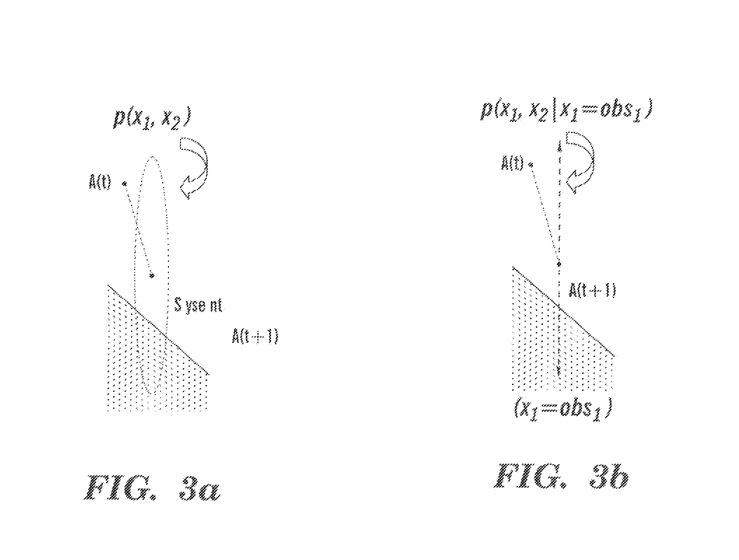

Second, different features (streams of data) should be given different priorities when the data observation occurs. In FIG. 3(a), consider task A, where distribution p at time t+1 is represented by an elliptical confidence boundary. The question is, if only one observation can be made either of X₁ or X₂, which observation should be made? Suppose X₁ is chosen and the observed value x₁ happens to be the mean. Then the elliptical region degenerates into a vertical line segment in FIG. 3(b), representing the conditional distribution p(X₂ X₁=x₁) will not run across the decision boundary, which enables the user to make a classification with a much higher confidence.

In summary, from p the user can derive the following guideline for load shedding: For task A, it is more beneficial to observe X₂ than X₁; for C, X₁ than X₂; for B, neither observation is critical for classification.

To make intelligent load shedding decisions at time t, p must be known, the distribution of a point's position at time t+1. In other words, the temporal locality of the data should be captured, and model the movement of a point in the feature space.

Assume a point's location in the feature space at time t+1 is solely dependent on its location at time t. Then build a finite discrete time Markov chain to model a point's movement as a stochastic process.

Assuming that features are independent to each other with regard to a points' movement in the feature space allows the user to build a Markov model on each feature. More specifically, let X be a feature that has M distinct values. The goal is to learn a state transition matrix K of size M×M, where entry Kᵢⱼ is the probability that feature X will take value j at time t+1 given X=i at time t.

K is derived through the maximum likelihood estimation (MLE). The MLE of the transition matrix K is given by

$${K}_{ij} = \frac{{n}_{ik}}{{\sum }_{k} {n}_{ik}} i . e . ,$$

the fraction of transitions from i to j among transitions from i to k, for all possible k. To adapt to potential concept shifts in the streaming data, (i.e., to allow for the change of behavior of a point's movement in the feature space) we can choose to use a finite sliding window of recent history for maximum likelihood estimation.

This disclosure presents a best effort solution to the load shedding problem previously discussed. Beginning with an algorithm, which is based on a naïve analysis of the expected Bayes Risk over all classification tasks. A portion of the expected Bayes Risk, which we call the Expected Observational Risk, should be used as the metric for feature based load shedding.

In Bayesian theory, the study of risk of misclassification by using a loss function is studied. Let δ(cᵢ|cⱼ) denote the cost of predicting class cᵢ when the data is really of class cⱼ. Then, at a given point x̅ in the feature space, the risk of our decision to label x̅ as class cᵢ out of K classes is:

$$R \text{(} {c}_{i} \vert \vec{x} ) = {\sum }_{j = 1}^{K} δ ( {c}_{i} \vert {c}_{j} ) P ( {c}_{j} \vert \vec{x} ) \qquad ( 1 )$$

### Where P(cⱼ| x̅) is the posterior probability that x̅ belong to class cⱼ. One particular loss function is the zero-one loss function, which is given by

$$δ ( {c}_{i} \vert {c}_{j} ) = \{ \begin{matrix}0 & if i = j \\ 1 & if i \neq j\end{matrix}$$

under which, the conditional risk in Equation 1 can be simplified as

R(cᵢ| x̅)=1−P(cᵢ| x̅) (2)

Bayes risk is used to guide classifier training so that the learned classifier 20 conforms with applications' error requirements. The loss function can be adjusted to reflect the user's different tolerance to different type of errors.

The same criterion must be adopted for load shedding. In other words, if the underlying classifier 20 is tuned to minimize Bayes risk defined by a certain loss function, then it only makes sense that our load shedding mechanism is optimized under the same guideline.

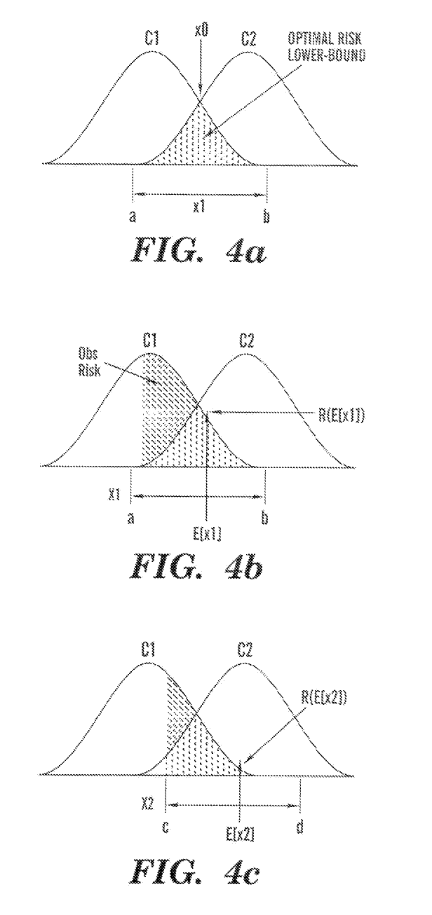

Let p(C₁|x) and p(C₂|x) be the posterior distribution of two classes C₁ and C₂. Without loss of generality, FIG. 4(a) shows the two distributions as two Bell curves. At point x₀, there is p(C₁|x)=p(C₂|x). In other words, x₀ is the classification boundary of C₁ and C₂. Further assume feature value X₁ of time t+1 has a uniform distribution within range [a,b].

If X₁=x₁ is known at time t+1, an optimal decision may be rendered, which is to predict the class that has higher posterior probability at x₁. Assuming 0/1 loss, the optimal risk at x₁ is the value of the smaller posterior probability. Therefore, given that x₁ distributes uniformly within [a,b], the expected optimal risk is the average of the shaded area in FIG. 4(a).

This expected optimal risk couldn't be further reduced by improving the underlying classifier 20 or by any other means. In fact, it is the unavoidable, lowest risk, as it is dictated by the nature of the class posterior probabilities.

Then, what will be the risk if the user does not know the exact value of X₁ at time t+1? A prediction still needs to be made that C₂ is predicted. Then the total Bayes Risk is the shaded areas in FIG. 4(b), and we can see the risk is not optimal at data points where C₁ should have been the optimal decision. Compared with the optimal risk, the increased portion, which is called the Observational Risk, is shown as the extra shaded areas in FIG. 4(b).

Assume a classification task involves two features X₁ and X₂ shown in FIG. 4(b) and FIG. 4(c), where the user needs to decide which feature to observe. As shown in the figure, X₂ has a different distribution at time t+1 (uniform within [c,d] form X₁, and consequently different expected value E(X₂) and different Observational Risk.

By observing the value of a feature the Observation Risk associated with that feature maybe eliminated. Clearly, feature X₁ should be chosen for observation, because as shown in FIG. 4, its area that corresponds to the Observational Risk is larger.

A potential pitfall is to observe the feature whose expected value gives a lower risk. This would opt to observe feature X₂, because it has a much lower risk value at its expected location E(X₂), as shown in FIG. 4.

Bayes risk consist of two parts, and only one part, the Observation Risk, can be eliminated by making observations. The other part, the Optimal Risk, is unavoidable, and data observation cannot lead to a risk lower than this lower bound.

As data observations can only reduce the Observational Risk portion of Bayes Risk, it makes sense to use Observational Risk instead of the full Bayes Risk as the optimization goal for load shedding.

Q_{obs}, is proposed as a new metric, to guide data observation. The superiority of Q_{obs} over Q_{Bayes} is due to its focus on the reducible risks.

The Q_{obs} Metric: At each location x̅ in the feature space, there is an optimal decision given by the underlying classifier, suppose it is c*. Clearly c* is given by:

c*=argnin R(c₁| x̅) (3)

### The expected risk for classifying a point x̅ as class cₖ can be represented by R_{before}(cₖ)=E x̅[R(cₖ| x̅)]=∫ _{x̅}R(cₖ| x̅)p( x̅)d x̅=∫ _{x̅}R(c*| x̅)p( x̅)d x̅ Optimal Risk Lower bound+∫ _{x̅}[R(cₖ| x̅)−R(c*| x̅)]p( x̅)d x̅Expected Observational Risk.

It is clear from Equation 4 that the expected risk for an un-observed data point consists of two parts.
The first part

$${\int }_{\vec{x}}^{ } R ( c * \vert \vec{x} ) p ( \vec{x} ) d \vec{x} ,$$

is the Expected Optimal Risk, which is the lowest possible risk that the underlying central classification server 20 can achieve.
The second part,

$${\int }_{\vec{x}}^{ } [ R ( {c}_{k} \vert \vec{x} ) - R ( c * \vert \vec{x} ) ] p ( \vec{x} ) d \vec{x} ,$$

is the expected risk increase over the lower bound, which is caused by a non-optimal prediction due to the central classification server's 20 lack of knowledge about the true data. This is the portion that observation of data affects the most—it is completely eliminated after the full observation of all features.

Therefore, the first features should be observed that lead to the largest reduction of the second part of Bayes Risk, the Observational Risk, which only apply to un-observed (or partially observed) data.

The expectation of the Observational Risk referred to as R^{obs} for un-observed or partially observed data is then:

$${R}_{before}^{obs} ( {c}_{k} ) = {\int }_{\vec{x}}^{ } [ R ( {c}_{k} \vert \vec{x} ) - R ( c * \vert \vec{x} ) ] p ( \vec{x} ) d \vec{x} \qquad ( 5 )$$

### Which is an integration over the elliptical area in FIG. 3(a). Note p( x̅) is a shorthand for pₜ₊₁( x̅), which is derived from the current distribution and the state transition matrix K of the Makov Model.

pₜ₊₁( x̅)=pₜ( x̅)K

The optimal prediction δ is the prediction that minimizes the expected risk:

$$\tilde{o} = {arg min}_{k} {R}_{before}^{obs} ( {c}_{k} ) = {arg min}_{k} {E}_{\vec{x}} [ R ( {c}_{i} \vert \vec{x} ) - R ( c * \vert \vec{x} ) \qquad ( 6 )$$

Therefore the expected risk before any observation is the risk of classifying the point as class δ. Intuitively, if the distribution has less overlap with the decision boundary, then the Expected Observational Risk will have a lower value. Similarly, the risk after the first observation R_{after} can also be decomposed into two parts, in much the same way as the decomposition of Equation 4 goes. Therefore the Observational Risk after observing feature xⱼ is given by:

$${R}_{after}^{obs} \text{(} {c}_{k}^{′} \vert {obs}_{j} ) = {\int }_{( l \vert {χ}_{i}^{′′} {obs}_{j} )}^{ } [ R ( {c}_{k}^{′} \vert \vec{x} ) - R ( c * \vert \vec{x} ) p ( \vec{x} \vert {obs}_{j} ) d \vec{x}$$

Now, O_{bsj} can be replaced with its expectation. This gives Q_{Obs}, which measures the gain of Observational Risk after observing the feature Xⱼ. Here cₖ is the predicted class before the observation, and c′ₖ is the predicted class after the observation.

$${Q}_{obs} ( {X}_{j} ) = {R}_{before}^{obs} ( {c}_{k} ) - {R}_{after}^{obs} ( {c}_{k}^{′} \vert E [ {x}_{j} ] ) \qquad ( 7 )$$

The above gives the guideline for picking the first feature for observation. Similar procedures maybe used to maximize Expected Observational Risk reductions before and after making the kₜₕ feature observation for a task. Eventually, with full observation the risk is reduced to the optimal risk at the observed location x̅_{obs}, which solely depends on the underlying classifier and the location itself, without any contribution from the data observation error.

Therefore, the generalized metric Q_{Obs} measures the quality of making the kₜₕ observation xₖ, which is conditioned on the feature values already observed so far (obs₁, obs₂, obsk-₁) and the expected value of the feature xₖ that shall be observed.

Q_{Obs}(Xₖ)=R^{obs}(c_{k|obs1, . . . ,k-1})−R^{obs}(c′ₖ| . . . ,k−1,E[xₖ]) (8)

### Obviously, Equation 7 is a special case of Equation 8 where the set of already observed features is empty.

The best feature first algorithm (BFF) is derived based on Equation 8. BFF is invoked once in every time unit, which utilizes the metric Q_{obs} to repeatedly pick the next best feature to observe until the capacity for the time unit is consumed.

Intuitively, in Algorithm 1, at the beginning of each time unit the user first computes the predicted distributions for each feature using Markov chains, and then computes an expected decision for each task based on the predictions. Then the user repeatedly picks to observe the best unobserved feature over all tasks that lead to the largest reduction in Expected Observational Risk. By doing so, the user minimizes the Expected Observational Risk over all tasks.

While conceptually clear, the BFF algorithm has a few implementation and computation issues that require further elaboration.

Computing the Expected Risk: The BFF algorithm requires computing the Expected Observational Risk. For example, to compute R_{before}^{obs}(cₖ) in Equation 5 for a task with feature vector distribution p( x̅), we need to know two sets of values.
The risk value R(cᵢ| x̅) for feature vector x̅ can be obtained from the underlying Bayesian classifier, which computes an estimated posterior P(cᵢ|x) from likelihood P(x|cᵢ) and estimates risk accordingly.
The movement distribution probability p( x̅) for feature vector x̅ can be obtained from the Markov models. Suppose x̅ has k features, then the probability for the full feature vector is p( x̅)=πᵢ₌₁^{k}p(xᵢ), based on the assumption of feature movement independence. Here each p(xᵢ) on an individual feature is computed using the corresponding Markov model.

Algorithm 1—The Best Feature First (BFF) Algorithm

Inputs: A total of n classification tasks, where each task T₁ has k streaming data sources (features). For the current time unit, some or all of the N=n×k stream may have new data available.

Outputs: Decisions δᵢ(iε1, . . . , n) for each of the n tasks.

Static variables: One next feature distribution vector p(x), and one Markov model k built on data in a sliding window, for each of the N streams K built on data in a sliding window, for each of the N streams.

How to Use: Invoke once per load shedding time unit.
1. Compute the predicted feature distribution p(x) for each feature x, based on the previous p(x) value and the Markov model K.
2. Compute the predicted decision δᵢ(iε1, . . . , n) for each of the n tasks, based on the predicted feature distribution p(x)(Equation 6).
3. For all features xⱼ, compute Q_{obs}(xⱼ) based on Equation 8
4. observed_count←0
5. while still data and observed_count<Capacity do
6. Pick the unobserved stream xⱼ with the highest Q_{obs}(xⱼ) value across all features of all tasks, and observe its actual data value.
7. Update distribution p(xⱼ) to a unit vector to reflect the observation made.
8. Update the decision δᵢ for the task Tᵢ that stream xⱼ belongs to, based on the new feature distribution p(xⱼ)(Equation 6).
9. Update the Q_{obs} values for the remaining unobserved streams belonging to task Tᵢ (Equation 8).
10. observed_count←observed_count+1
11. end while
12. Update the Markov model for each stream based on observations made in this and previous time unit (add counts for newly observed transitions, and remove those expired out of the sliding window).

Then computation of the Expected Observational Risk takes place by integrating over the domain of feature x̅, which is discussed next.

Numeric Integration Over Feature Space: To compute the Expected Observational Risk the user needs to integrate over the entire feature space of a task. This is computationally expensive if the task has a high dimension. To reduce the computational complexity use integration by sampling.

In short, based on the independence in movement assumption, perform 1 dimensional Monte Carlo sampling on each feature based on its predicted data distribution, and then assemble the results from all features to form samples for the full feature vector, which can then be used to compute the expected risk as an un-weighted average.

Markov Model Maintenance: We separately maintain one Markov chain for each feature. If a feature has M distinct values, a matrix of M×M counters is maintained for the feature. Due to load shedding, there may not be consecutive observations on a particular feature to fill up the counters. As such, we adopt an ad-hoc method to force some consecutive observations in order to fill the counters. The dynamic nature of the streaming environment can also be addressed by building the Markov model on a sliding window of data.

Algorithm Cost Analysis: The most expensive step in BFF is to compute the metric Q_{obs} for each feature of each classification tasks. Suppose there are n tasks with k dimensions each (therefore there are a total of N=n×k streams), and out of them the user has the capacity to observe m streams. Before we make any observation, we will perform a total of O(N) computation of Q_{obs} metrics. Then after making each observation, the user only needs to update metric values for O(k) un-observed features for the affected task, which makes the total Q_{obs} update cost to be O(m×k). Therefore, each round we perform [O(N)+O(m×k)] computations of the Q_{obs} metric.

The sampling step of Qobs computation, as discussed above for integration, only needs to be done once per time unit. Suppose we obtain h samples on each feature, the total cost of sampling is then O(h×N).

Maintaining the Markov models for each feature requires M×M space complexity, and M×M time complexity for counter updates in each time unit. Therefore, we have a total of N×M×M updates for Markov model maintenance.

An alternative algorithm that reduces the cost of metric computations is the Highest Variance of Worst Task (HVWT). Intuitively, instead of completely operate on features, this algorithm is a hybrid of task based and feature based algorithms, in which we pick a task first before picking a feature from the task. First, we pick the worst task that has the highest overall Observational Risk, by using Equation 5, which is computed on task. Then, instead of observing all the features in this worst task (as a task based algorithm, such as LoadStar), we only pick one best feature (in term of observation) from this task to observe. We then update the task's Observational Risk value after this observation, and start over again to pick the worst task and a best feature, and repeat this process until the capacity is reached.

To pick the best feature we utilize the following intuition. Frequently, a feature with a high variance in terms of movement destination will contribute more to the overall Observational Risk. For example in FIG. 3, feature X₂ for task A has a high variance in movement, and observing which will result in a larger Observational Risk reduction than observing feature X₁. Intuitively, the higher the variance in movement, the more likely the destination will run across decision boundary, and therefore the larger its contribution to total Observational Risk. Of course a high variance does not always lead to a larger Observational Risk, e.g. in FIG. 2 it is the lower variance feature (X₁) in task C that contributes more to the Observational Risk, therefore we may not always be picking the best feature by this approximation.

Assuming feature movement patterns usually last for some period of time, the variance of movement for each feature can be computed once and reused in each time unit, only to be re-evaluated periodically. Therefore here in each time unit we asymptotically avoid computing the [O(N)+O(m×k)] Q_{obs} metrics, and instead only do O(n) computations of Expected Observational Risk for each task.

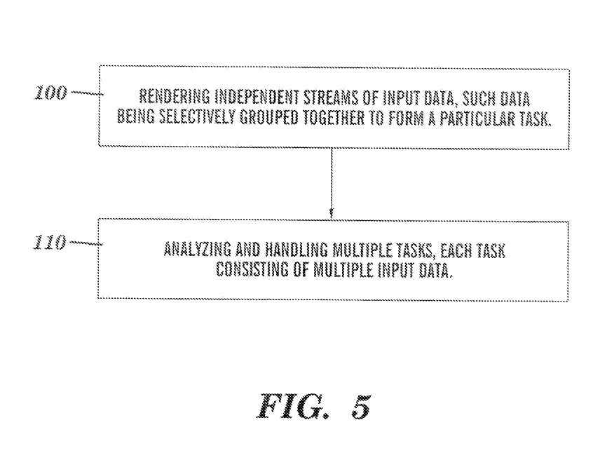

Referring to FIG. 5, a method for feature based load shedding in classification, is shown. At step 100, independent streams of input data is rendered, such that the data is selectively grouped together to form a particular task. Then, at step 110, multiple tasks are analyzed and handled, each task consisting of multiple input data.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system for feature based load shedding in classification, comprising:
a plurality of data sources, each data source being configured to render independent streams of input data, such data being selectively grouped together to form a particular classification task; and
a central classification server configured to analyze and handle multiple tasks, each task consisting of multiple input data, the central classification server further configured to analyze the data for knowledge-based decision-making, and the central classification server being communicatively engaged via a network to the plurality of data sources.

2. The system of claim 2, wherein the central classification server is further configured to execute Markov statistical model for movement prediction.

3. The system of claim 2, wherein the central classification server is further configured to execute Bayes Risk statistical model as the metric for feature based load shedding.

4. A method for feature based load shedding in classification, including:
rendering independent streams of input data, such data being selectively grouped together to form a particular task; and
analyzing and handling multiple tasks, each task consisting of multiple input data, and analyzing the data for knowledge-based decision-making.
